(19) United States
(12) Patent Application Publication
(10) Pub. No.: US 2014/0313644 A1
(43) Pub. Date: Oct. 23, 2014

(54) RETAINING INSERT FOR AN ELECTRICAL PANELBOARD ASSEMBLY

(71) Applicant: GENERAL ELECTRIC COMPANY, Schenectady, NY (US)

(72) Inventors: Kiran Bhattar, Hyderabad, Andhra Pradesh (IN); Jonathan David Potter, Southington, CT (US); Veeresh Somalilngayya, Hyderabad, Andhra Pradesh (IN)

(73) Assignee: General Electric Company, Schenectady, NY (US)

(21) Appl. No.: 13/867,428

(22) Filed: Apr. 22, 2013

(51) Int. Cl. H02B 1/04

(52) U.S. Cl. CPC H02B 1/04
USPC 361/673

(57) ABSTRACT

A retaining insert coupleable to an enclosure for a primary circuit breaker and a pair of opposing circuit breakers arranged to define a recess. The retaining insert includes a base portion configured to be disposed between the primary circuit breaker and the pair of opposing circuit breakers, the base portion configured to be operatively coupled to the enclosure. Also included is a tab portion extending from the base portion and configured to retain the pair of opposing circuit breakers.

### BACKGROUND OF THE INVENTION

The subject matter disclosed herein relates to circuit breakers, and more particularly to a retaining insert for electrical circuit breaker panelboard assemblies.

Electrical circuit breaker panelboard assemblies often include a primary circuit breaker and a secondary circuit breaker for selectively switching an electrical supply to the panelboard between a primary source, such as a utility, and an auxiliary source, such as a generator. It is necessary that the primary circuit breaker and the secondary circuit breaker are prohibited from being simultaneously in a powered condition. A mechanical interlock assembly may be employed to interconnect a primary handle operated switch and a secondary handle operated switch to prevent both handles from being simultaneously disposed in a position that results in a powered condition for the primary circuit breaker and the secondary circuit breaker. The mechanical interlock is typically mounted to a cover for the front side electrical circuit breaker panelboard assembly, such that removal of the cover results in removal of the mechanical interlock, thereby leaving the primary handle and the secondary handle exposed to potential simultaneous positioning in a powered condition.

Another issue associated with existing electrical circuit breaker panelboard assemblies relates to adequate retaining of the secondary circuit breaker, which is typically merely a plug-in type. For such plug-in types, inadvertent removal of the secondary circuit breaker is undesirable. Additionally, a recess is often present between the secondary circuit breaker and a branch circuit breaker, thereby exposing live circuitry. Such exposure may pose various hazards to nearby individuals and environments.

### BRIEF DESCRIPTION OF THE INVENTION

According to one aspect of the invention, provided is a retaining insert coupleable to an enclosure for a primary circuit breaker and a pair of opposing circuit breakers arranged to define a recess. The retaining insert includes a base portion configured to be disposed between the primary circuit breaker and the pair of opposing circuit breakers, the base portion configured to be operatively coupled to the enclosure. Also included is a tab portion extending from the base portion and configured to retain the pair of opposing circuit breakers.

According to another aspect of the invention, an electrical protection system includes an enclosure comprising a base wall, a first sidewall and a second sidewall, the first sidewall and the second sidewall extending relatively perpendicularly from the base wall, wherein the enclosure is configured to at least partially surround a primary circuit breaker and a pair of opposing circuit breakers that define a recess. Also included is a bracket. The bracket includes a base portion extending from proximate the first sidewall to the second sidewall and mechanically fastened to the first sidewall and the second sidewall. The bracket also includes a tab portion extending from the base portion and disposed proximate the recess, the tab portion configured to retain the pair of opposing circuit breakers.

According to yet another aspect of the invention, provided is a support plate coupleable to an enclosure having a base assembly for operatively supporting a primary circuit breaker and a pair of opposing circuit breakers that define a recess. The support plate includes a main portion having a cutout region. Also included is a tab portion extending from the main portion and configured to retain the pair of opposing circuit breakers. Further included is a support plate brace operatively coupled to the main portion and extending to a location proximate the base wall and operatively coupled to the base assembly.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a front, perspective view of an electrical panelboard assembly according to a first embodiment;

FIG. 2 is a perspective view of a retaining insert of the first embodiment of the electrical panelboard assembly;

FIG. 3 is a front, elevational view of the electrical panelboard assembly of the first embodiment having a cover enclosing at least a portion of the electrical panelboard assembly;

FIG. 4 is a front, elevational view of the cover for the first embodiment of the electrical panelboard assembly;

FIG. 5 is a front, perspective view of the electrical panelboard assembly of the first embodiment having an interlock assembly in a first position;

FIG. 6 is a front, perspective view of the interlock assembly in a second position;

FIG. 7 is a front, perspective view of the electrical panelboard assembly according to a second embodiment;

FIG. 8 is a perspective view of a support plate of the second embodiment of the electrical panelboard assembly;

FIG. 9 is a front, elevational view of the electrical panelboard assembly of the second embodiment having a cover enclosing at least a portion of the electrical panelboard assembly; and

FIG. 10 is a front, elevational view of the cover for the second embodiment of the electrical panelboard assembly.

The detailed description explains embodiments of the invention, together with advantages and features, by way of example with reference to the drawings.

### DETAILED DESCRIPTION OF THE INVENTION

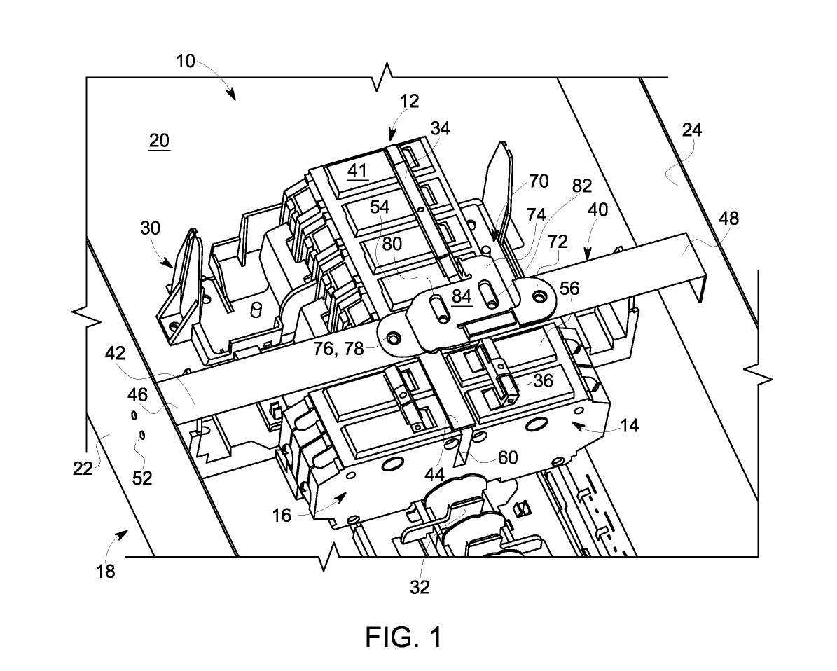

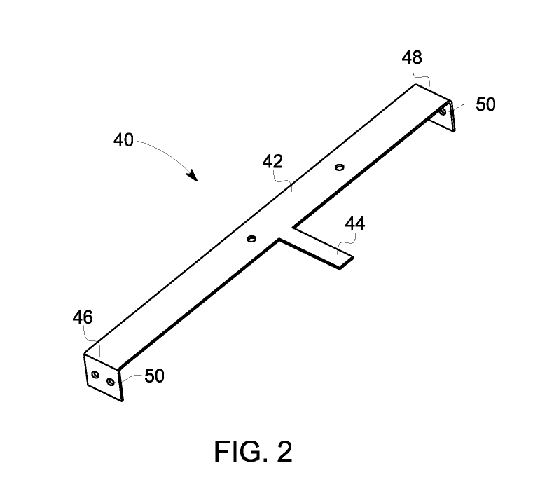

Referring to FIGS. 1 and 2, an electrical panelboard assembly according to a first embodiment is referenced generally with numeral 10. The electrical panelboard assembly 10 is configured to be employed in conjunction with numerous applications, such as an electrical protection system, and is suitable for both indoor and outdoor embodiments. The electrical panelboard assembly 10 includes a primary circuit breaker 12, a secondary circuit breaker 14 and a branch circuit breaker 16. The secondary circuit breaker 14 and the branch circuit breaker 16 may be collectively referred to herein as a pair of opposing circuit breakers. Typically, a plurality of branch breakers will be employed, but for simplicity of description, a single branch circuit breaker is illustrated. The primary circuit breaker 12, the secondary circuit breaker 14 and the branch circuit breaker 16 are disposed at least partially within an enclosure 18. The enclosure 18 comprises a base wall 20, a first sidewall 22, a second sidewall 24, a first end wall (not shown) and a second end wall (not shown), which together define a space for housing the primary circuit breaker 12, the secondary circuit breaker 14 and the branch circuit breaker 16. The first sidewall 22, the second sidewall 24, the first end wall and the second end wall are integrally formed with the base wall 20, with each extending relatively perpendicularly from the base wall 20.

A base assembly 30 is operatively coupled to the base wall 20 and provides a mount interface for the primary circuit breaker 12. A plurality of studs and various other mechanical fasteners directly or indirectly secure the primary circuit breaker 12 to the base assembly 30 in a fixed manner. The base assembly 30 includes a plurality of socket arrangements 32 configured to receive the secondary circuit breaker 14 and the branch circuit breaker 16, as well as a plurality of other branch circuit breakers. The secondary circuit breaker 14 and the branch circuit breaker 16 include mating socket receptacles (not shown) corresponding to the plurality of socket arrangements 32 to achieve a plug-in connection for the secondary circuit breaker 14 and the branch circuit breaker 16.

The primary circuit breaker 12 includes a primary breaker handle 34 in operable communication with a primary circuit breaker switch for switching between a primary breaker powered position, also referred to herein as a primary breaker first position or as an ON position, and a primary breaker unpowered position, also referred to herein as a primary breaker second position or as an OFF position. FIG. 1 illustrates the primary breaker handle 34 in the OFF position, however, it can be appreciated that shifting the primary breaker handle 34 toward the second sidewall 24 places the primary breaker handle 34 in the ON position. Similarly, the secondary circuit breaker 14 includes a secondary breaker handle 36 in operable communication with a secondary circuit breaker switch for switching between a secondary breaker powered position (i.e., ON position) and a secondary breaker unpowered position (i.e., OFF position). FIG. 1 illustrates the secondary breaker handle 36 in the OFF position, however, it can be appreciated that shifting the secondary breaker handle 36 toward the second sidewall 24 places the secondary breaker handle 36 in the ON position.

A bracket 40, also referred to herein as a retaining insert, extends along a plane proximate a first side 41 of the primary circuit breaker 12, as well as the secondary circuit breaker 14 and the branch circuit breaker 16. The bracket 40 includes a base portion 42 and a tab portion 44, with the base portion 42 including a first end 46 and a second end 48, the first end 46 and the second end 48 located proximate the first sidewall 22 and the second sidewall 24, respectively. At least one end aperture 50 is disposed proximate the first end 46 and the second end 48, the at least one end aperture 50 corresponding to at least one sidewall aperture 52 extending through the first sidewall 22 and the second sidewall 24. The at least one end aperture 50 and the at least one sidewall aperture 52 are configured to receive mechanical fasteners for fixedly securing the bracket 40 to the enclosure 18, and more specifically the first sidewall 22 and the second sidewall 24. The base portion 42 extends across the enclosure 18 at a location proximate a lower end 54 of the primary circuit breaker 12 and an upper end 56 of the secondary circuit breaker 14.

The tab portion 44 is integrally formed with the base portion 42 and extends at least partially within a recess 60 located between the secondary circuit breaker 14 and the branch circuit breaker 16. Based on the “plug-in” nature of the secondary circuit breaker 14, the tab portion 44 reduces the likelihood of inadvertent removal of the secondary circuit breaker 14. Additionally, the tab portion 44 is a structural element that reduces the exposure of live electrical circuitry that may be accessed proximate the recess 60.

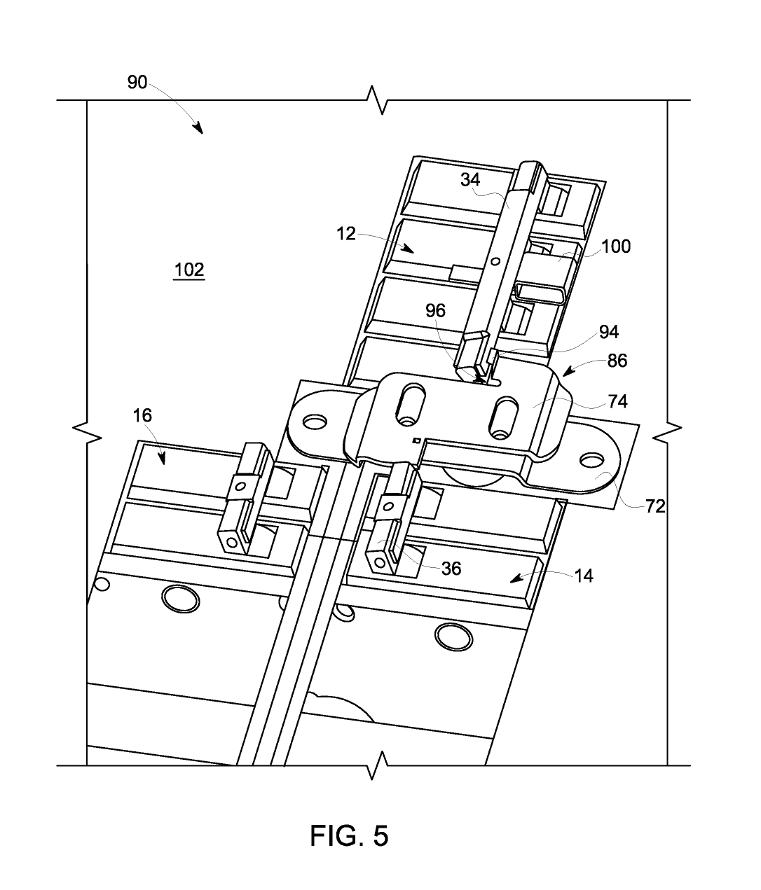

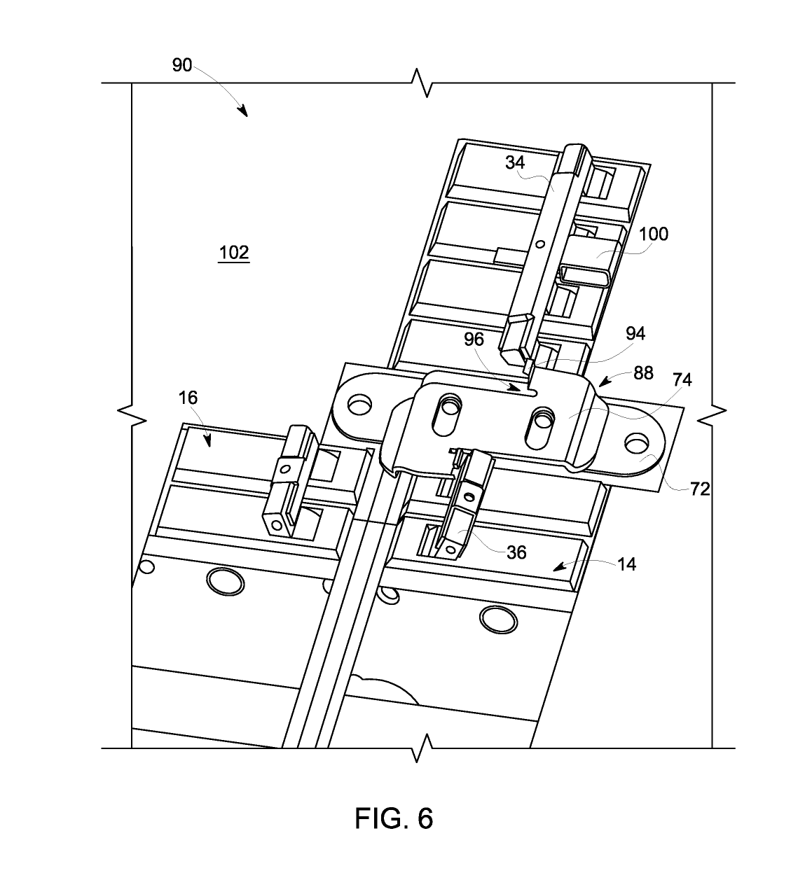

An interlock assembly 70 includes an interlock bracket 72 and a locking member 74. The interlock bracket 72 is fixedly mounted to the base portion 42 of the bracket 40 via one or more mechanical fasteners extending through at least one interlock bracket aperture 76 that corresponds to at least one base portion aperture 78. The locking member 74 includes at least one slot 80 extending in a longitudinal direction corresponding to the first sidewall 22 and the second sidewall 24 longitudinal directions. The at least one slot 80 is configured to receive a retaining member (not illustrated), such as a pin, that extends through the at least one slot 80 and retaining member apertures 82 disposed in the interlock bracket 72. The retaining member may include a head portion that extends partially over a first surface 84 of the locking member 74, thereby retaining the locking member 74, while providing a moveable engagement of the locking member 74 to the interlock bracket 72. Specifically, the locking member 74 is free to slide between a first position 86 and a second position 88 (shown in FIGS. 5 and 6), described in greater detail below.

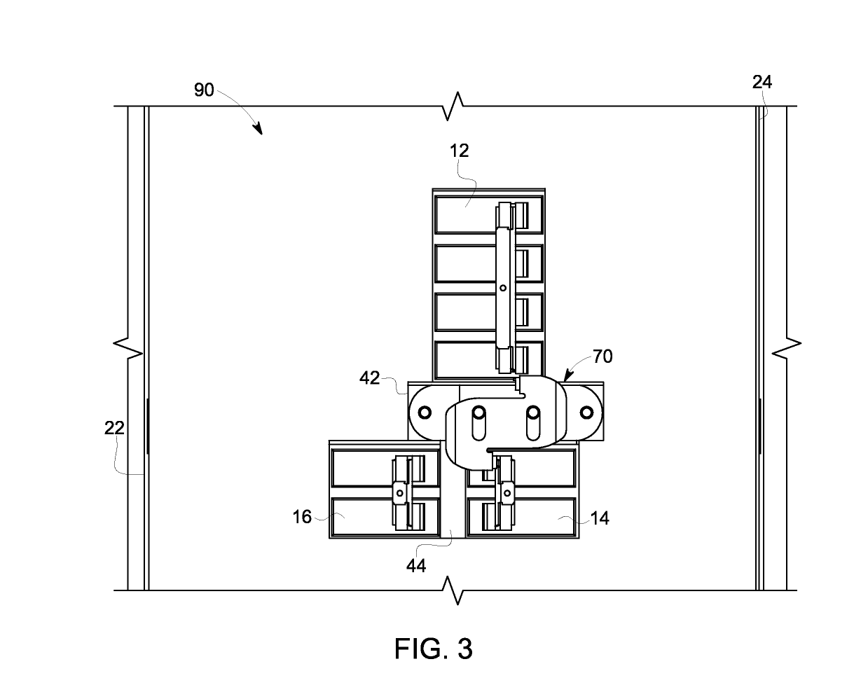

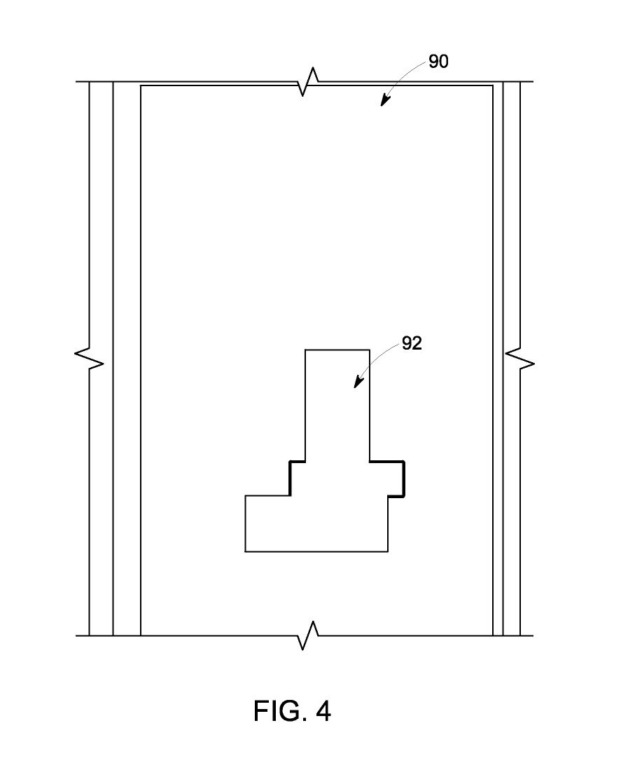

Referring now to FIGS. 3 and 4, a cover 90 disposed proximate an open side of the enclosure 18, and more particularly proximate a first edge of the first sidewall 22, the second sidewall 24, the first end wall and the second end wall. The cover 90 is operatively coupled to the enclosure 18 and is configured to reduce exposure of electrical components located within the enclosure 18. A cutout portion 92 of the cover 90 exposes at least a portion of the primary circuit breaker 12, at least a portion of the interlock assembly 70 and at least a portion of the secondary circuit breaker 14. Additionally, the cutout portion 92 also exposes at least a portion of the branch circuit breaker 16 and it is contemplated that several other branch circuit breakers may be exposed by the cutout portion 92. While illustrated and described as a full cutout, the cutout portion 92 may comprise a “knockout” portion that includes a relatively solid face for the cover 90, but includes a plurality of perforations patterned to correspond to desired exposure of the primary circuit breaker 12, the interlock assembly 70, the secondary circuit breaker 14 and the branch circuit breaker 16. The knockout portion may be removed by tearing along the perforations to provide the desired exposure.

Referring now to FIGS. 5 and 6, positioning of the locking member 74 is illustrated in greater detail. The first position 86 of the locking member 74 (FIG. 5) corresponds to a fully extended location of the locking member 74, relative to the interlock bracket 72. In the first position 86, an extending tab 94 is in close proximity to the primary breaker handle 34 and locks the primary breaker handle 34 in the primary breaker unpowered position (i.e., OFF position), based on the prevention of movement of the primary breaker handle 34 to the ON position. While in the first position 86, it can be appreciated that the secondary breaker handle 36 is free to move between the ON and OFF positions. In this way, the interlock assembly 70 does not allow simultaneous movement of the primary breaker handle 34 and the secondary breaker handle 36 to the ON positions. The second position 88 of the locking member 74 (FIG. 6) corresponds to a fully extended location of the locking member 74, relative to the interlock bracket 72. In the second position 88, a notched region 96 that may contain a tab similar to that of the extending tab 94 is in close proximity to the secondary breaker handle 36 and locks the secondary breaker handle 36 in the secondary breaker unpowered position (i.e., OFF position), based on the prevention of movement of the secondary breaker handle 36 to the ON position. While in the second position 88, it can be appreciated that the primary breaker handle 34 is free to move between the ON and OFF positions.

A blocking member 100 is disposed in operable communication with at least one of the primary circuit breaker 12 and the primary breaker handle 34. The blocking member 100 is configured to slide from side-to-side between a first blocking position and a second blocking position as a result of movement of the primary breaker handle 34 between the ON and OFF positions. The blocking member 100 is driven by movement of the primary breaker handle 34. The blocking member 100 may be driven by the primary breaker handle 34 in a variety of manners. In one embodiment, the blocking member 100 is directly coupled to the primary breaker handle 34, such that as the primary breaker handle 34 is moved toward the ON or OFF positions, the blocking member 100 is pushed or pulled, respectively, by the primary breaker handle 34. In an alternative embodiment, the blocking member 100 may be biased, such as by a spring, toward the OFF position of the primary breaker handle 34. Upon movement of the primary breaker handle 34 toward the ON position, the blocking member 100 is driven by the primary breaker handle 34.

Irrespective of the precise manner of driving the blocking member 100 by the primary breaker handle 34, when the primary breaker handle 34 is disposed in the ON position, the blocking member 100 is moved toward the second sidewall 24 and extends at least partially over a surface 102 of the cover 90, thereby reducing the likelihood of removal of the cover 90 during an ON condition of the primary breaker handle 34. A similar function is achieved with the interlock assembly 70 when the secondary breaker handle 36 is in the ON position. As described in detail above, the locking member 74 must be in the first position 86 to allow the secondary breaker handle 36 to be in the ON position. In the first position 86, at least a portion of the locking member 74 extends over the surface 102 of the cover 90, thereby reducing the likelihood of removal of the cover 90 during an ON condition of the secondary breaker handle 36. In conjunction, the blocking member 100 and the interlock assembly 70 reduce the ability of the cover 90 to be removed when either the primary breaker handle 34 or the secondary breaker handle 36 is disposed in the ON position.

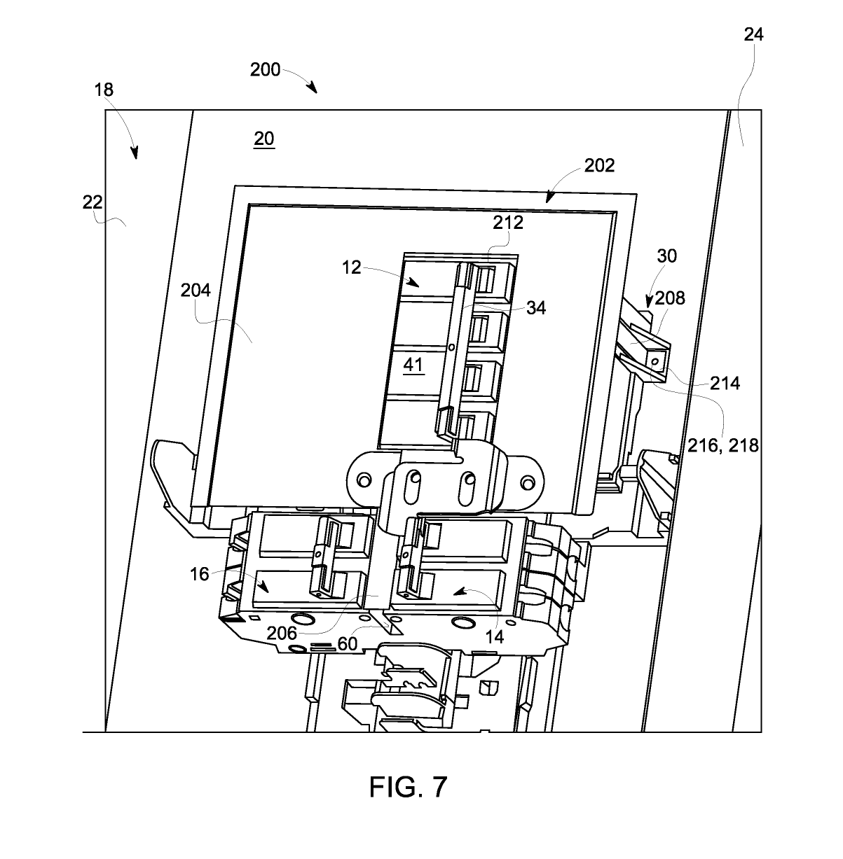

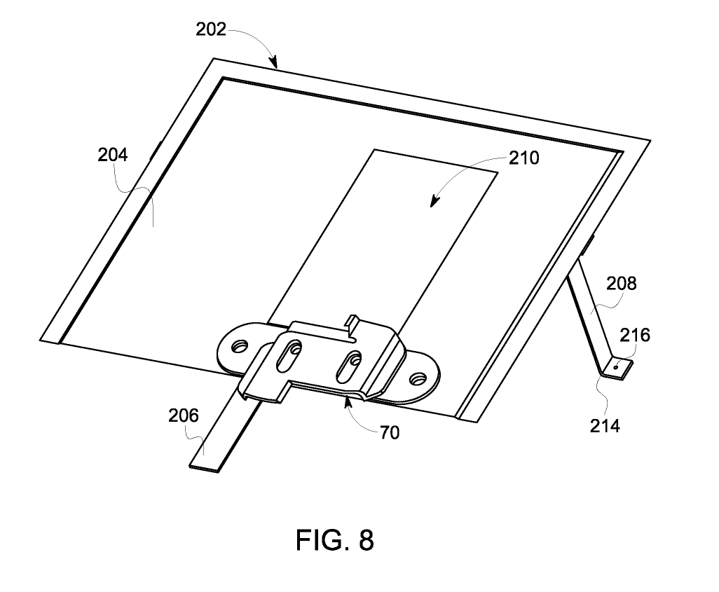

Referring now to FIGS. 7 and 8, an electrical panelboard assembly according to a second embodiment is illustrated and generally referred to with numeral 200. The second embodiment of the electrical panelboard assembly 200 is similar in many respects to that of the first embodiment, such that each component need not be discussed in further detail or repetitively. Where applicable, similar reference numerals used to describe the first embodiment may be employed.

In the exemplary embodiment, a support plate 202 is disposed along the first side 41 of the primary circuit breaker 12. The support plate 202 includes a main portion 204, a tab portion 206 and a support plate brace 208. The main portion 204 includes a cutout region 210 corresponding to a primary circuit breaker perimeter 212, thereby exposing a portion of the primary circuit breaker 12, including the primary breaker handle 34. The tab portion 206 is integrally formed with the main portion 204 and extends at least partially within the recess 60 located between the secondary circuit breaker 14 and the branch circuit breaker 16. Similar to the tab portion 44 of the first embodiment, based on the “plug-in” nature of the secondary circuit breaker 14, the tab portion 206 reduces the likelihood of inadvertent removal of the secondary circuit breaker 14. Additionally, the tab portion 206 is a structural element that reduces the exposure of live electrical circuitry that may be accessed proximate the recess 60.

The support plate brace 208 is operatively coupled to the main portion 204 and may be integrally formed with the main portion 204 such as by welding. The support plate brace 208 extends toward the base wall 20 and includes an end portion 214 that is operatively coupled to the base assembly 30. In the exemplary embodiment, an aperture 216 extending through the end portion 214 corresponds to a base assembly aperture 218 for mechanically fastening the support plate brace 208, and therefore the support plate 202 to the base assembly 30. Although illustrated and described as having a single support plate brace, typically a plurality of braces are employed to fixedly secure the support plate 202, with at least one brace on each side of the support plate 202. Additionally, it is contemplated that the support plate brace 208 is mechanically fastened to the base wall 20 of the enclosure 18.

The interlock assembly 70, described above in detail, is mounted to the support plate 202 in a similar manner as that of mounting to the bracket 40 of the first embodiment. Mounting of the interlock assembly 70 to the support plate 202 reduces the disturbance or interruption of operation of the interlock assembly 70 during opening or removal of the cover 90 from the enclosure 18.

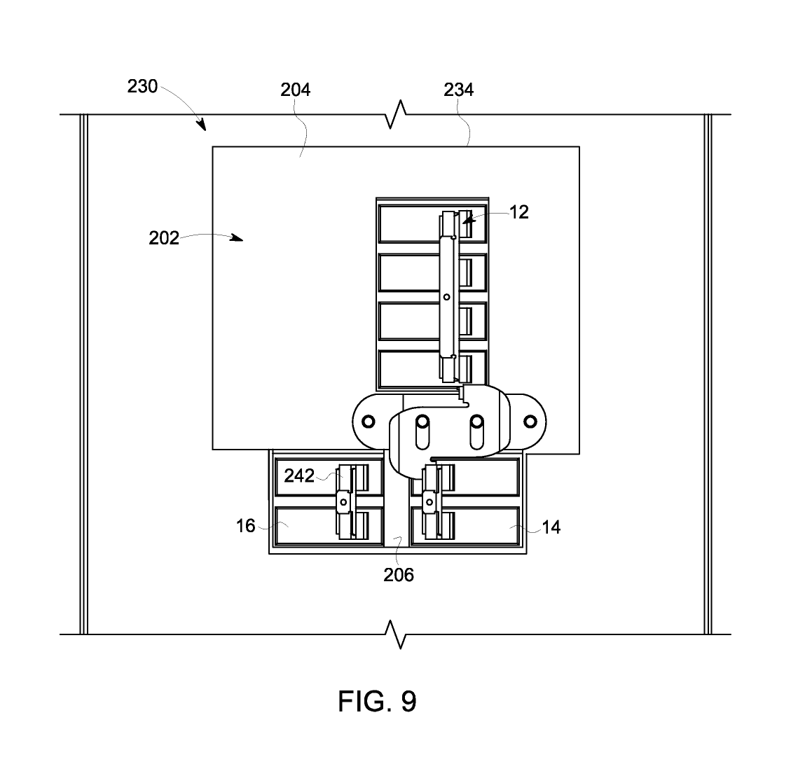

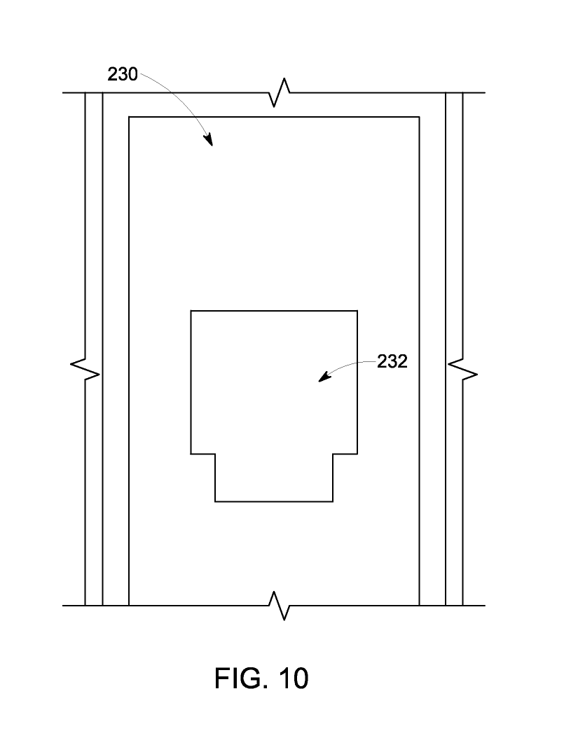

Referring to FIGS. 9 and 10, a second embodiment of a cover 230 is illustrated. The cover 230 includes a support plate cutout portion 232 that corresponds to a support plate perimeter 234 and exposes a portion of the secondary circuit breaker 14 and the branch circuit breaker 16. As described above in relation to the first embodiment, the support plate cutout portion 232 may instead comprise a knockout portion that includes a plurality of perforations, with the knockout portion being removable upon tearing away from the cover 230.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A retaining insert coupleable to an enclosure for a primary circuit breaker and a pair of opposing circuit breakers arranged to define a recess, the retaining insert comprising:
a base portion configured to be disposed between the primary circuit breaker and the pair of opposing circuit breakers, the base portion configured to be operatively coupled to the enclosure; and
a tab portion extending from the base portion and configured to retain the pair of opposing circuit breakers.

2. The retaining insert of claim 1, further comprising an interlock assembly comprising:
an interlock bracket operatively coupled to the base portion of the bracket; and
a locking member moveably engaged to the interlock bracket.

3. The retaining insert of claim 2, the locking member moveable between a first position and a second position, the locking member configured to lock the primary circuit breaker when the locking member is in the first position and configured to lock at least one of the pair of opposing circuit breakers when the locking member is in the second position.

4. The retaining insert of claim 1, further comprising a cover moveable between a closed position and an open position that exposes at least a portion of the primary circuit breaker, at least a portion of an interlock assembly and at least a portion of the pair of opposing circuit breakers.

5. The retaining insert of claim 4, further comprising a blocking member moveable between a first blocking position and a second blocking position, the blocking member configured to impede removal of the cover in the second blocking position.

6. The retaining insert of claim 5, further comprising a locking member moveable between a first position and a second position, the first position corresponding to disposal of the locking member over at least a portion of the cover to impede removal of the cover.

7. An electrical protection system comprising:
an enclosure comprising a base wall, a first sidewall and a second sidewall, the first sidewall and the second sidewall extending relatively perpendicularly from the base wall, wherein the enclosure is configured to at least partially surround a primary circuit breaker and a pair of opposing circuit breakers that define a recess; and
a bracket comprising:
a base portion extending from proximate the first sidewall to the second sidewall and mechanically fastened to the first sidewall and the second sidewall; and
a tab portion extending from the base portion and disposed proximate the recess, the tab portion configured to retain the pair of opposing circuit breakers.

8. The electrical protection system of claim 7, further comprising an interlock assembly comprising:
an interlock bracket operatively coupled to the base portion of the bracket; and
a locking member moveably engaged to the interlock bracket.

9. The electrical protection system of claim 8, the locking member moveable between a first position and a second position, the locking member configured to lock the primary circuit breaker when the locking member is in the first position and configured to lock at least one of the pair of opposing circuit breakers when the locking member is in the second position.

10. The electrical protection system of claim 8, further comprising a cover moveable between a closed position and an open position that exposes at least a portion of the primary circuit breaker, at least a portion of an interlock assembly and at least a portion of the pair of opposing circuit breakers.

11. The electrical protection system of claim 10, further comprising a blocking member moveable between a first blocking position and a second blocking position, the blocking member configured to impede removal of the cover in the second blocking position.

12. The electrical protection system of claim 10, further comprising a locking member moveable between a first position and a second position, the first position corresponding to disposal of the locking member over at least a portion of the cover to impede removal of the cover.

13. A support plate coupleable to an enclosure having a base assembly for operatively supporting a primary circuit breaker and a pair of opposing circuit breakers that define a recess, the support plate comprising:
a main portion having a cutout region;
a tab portion extending from the main portion and configured to retain the pair of opposing circuit breakers; and
a support plate brace operatively coupled to the main portion and extending to a location proximate the base wall and operatively coupled to the base assembly.

14. The support plate of claim 13, further comprising an interlock assembly comprising:
an interlock bracket operatively coupled to a first side of the support plate; and
a locking member moveably engaged to the interlock bracket.

15. The support plate of claim 14, the interlock bracket operatively coupled to the main portion of the support plate.

16. The support plate of claim 14, the locking member moveable between a first position and a second position, the locking member configured to lock the primary circuit breaker when the locking member is in the first position and configured to lock at least one of the pair of opposing circuit breakers when the locking member is in the second position.

17. The support plate of claim 13, the support plate brace welded to the main portion of the support plate.

18. The support plate of claim 13, comprising a cover moveable between a closed position and an open position that exposes at least a portion of the primary circuit breaker, at least a portion of an interlock assembly and at least a portion of the pair of opposing circuit breakers.

19. The support plate of claim 18, the cutout portion corresponding to a main portion perimeter of the support plate and a pair of opposing circuit breakers perimeter.
